(19) United States
(12) Patent Application Publication
(10) Pub. No.: US 2020/0033109 A1
(43) Pub. Date: Jan. 30, 2020

(54) WORKPIECE MEASUREMENT DEVICE, WORKPIECE MEASUREMENT METHOD AND NON-TRANSITORY COMPUTER READABLE MEDIUM RECORDING A PROGRAM

(71) Applicant: FANUC CORPORATION, Minamitsuru-gun (JP)

(72) Inventor: Yuuki SUGITA, Yamanashi (JP)

(21) Appl. No.: 16/447,279

(22) Filed: Jun. 20, 2019

(30) Foreign Application Priority Data
Jul. 26, 2018 (JP) 2018-140257

(51) Int. Cl. G01B 5/008; G06F 3/14; G06F 3/0488

(52) U.S. Cl. CPC G01B 5/008; G06T 7/13; G06F 3/04883; G06F 3/14

(57) ABSTRACT

To reduce the work load required to measure a workpiece. A workpiece measurement device according to the present invention includes a display unit configured to display an image of a workpiece, a measurement object acquisition unit configured to accept designation of a measurement object in the image of the workpiece, and to detect a measurement object structure corresponding to the designated measurement object, a measurement item setting unit configured to accept designation of a measurement item in the image of the workpiece, and a measurement program generation unit configured to generate a measurement program including a set measurement point and a set approach point corresponding to the measurement item designated by the measurement item setting unit with respect to the measurement object structure, and a set measurement path including the measurement point and the approach point.

This application is based on and claims the benefit of priority from Japanese Patent Application No. 2018-140257, filed on 26 Jul. 2018, the content of which is incorporated herein by reference.

### BACKGROUND OF THE INVENTION

### Field of the Invention

The present invention relates to a workpiece measurement device, a workpiece measurement method and a non-transitory computer readable medium recording a program.

### Related Art

There is a conventionally-known technique for measuring a workpiece serving as a machining object, for the purpose of machining with a machine tool. A measurement method for measuring a workpiece by using a touch sensor (touch probe) or a laser sensor has an advantage in terms of high resolution and accuracy in general and also has a disadvantage in terms of long measurement time due to narrow measurable range at once. In the case of measuring a workpiece by a touch sensor, as an example, an operator manually moves the touch sensor so as not to damage the workpiece or the touch sensor.

Accordingly, an excessive work load is imposed on the operator. A mechanism allowing to reduce such a work load is known, which automatically generates a measurement program for moving a touch sensor upon reception of input of coordinates of a measurement point and an approach point. The operator still has to recognize and input a plurality of coordinates of such points while considering the coordinate system. Accordingly, an excessive work load is still imposed on the operator. On the other hand, the method of measuring the shape, the position and the like of a workpiece by using the image acquired by a visual sensor or the like has an advantage in that a wide range is measurable in a short time, and also has a disadvantage in that the method is not practical in the case of setup of machining, such as setting of a coordinate system of a workpiece, from the viewpoint of measurement resolution and repeatability. A workpiece measurement method allowing to solve such problems is proposed, in which the measurement method by use of a touch sensor or a laser sensor is combined with an image of a workpiece, thereby compensating respective disadvantages. For example, Patent Document 1 discloses the method including the steps of displaying the image of a workpiece acquired by a visual sensor on a display unit, accepting the designation of a measurement point and an approach point by a user's touch operation on the image, and generating an automatic measurement program by use of a touch probe, on the basis of the coordinates of the points.
Patent Document 1: Japanese Unexamined Patent Application, Publication No. 2018-018155

### SUMMARY OF THE INVENTION

However, the technology disclosed in Patent Document 1 may require knowledge and experience regarding the setting of measurement points and approach points, and complicated procedures for setting a large number of measurement points, approach points and directions depending on some measurement objects. Therefore, if a measurement object is able to be designated with fewer sensuous operations, higher convenience is able to be realized.

The object of the present invention is to reduce the work load required to measure a workpiece.

(1) A workpiece measurement device (for example, a workpiece measurement device 1 to be described below) according to the present invention includes a display unit (for example, a display unit 15 to be described below) configured to display an image of a workpiece, a measurement object designation unit (for example, a measurement object acquisition unit 11c to be described below) configured to accept designation of a measurement object in the image of the workpiece, a structure detection unit (for example, a measurement object acquisition unit 11c to be described below) configured to detect a measurement object structure corresponding to the measurement object designated by the measurement object designation unit, a measurement item designation unit (for example, a measurement item setting unit 11d to be described below) configured to accept designation of a measurement item in the image of the workpiece, and a measurement program generation unit (for example, a measurement program generation unit 11e to be described below) configured to generate a measurement program including a set measurement point and a set approach point corresponding to the measurement item designated by the measurement item designation unit with respect to the measurement object structure, and a set measurement path including the measurement point and the approach point.

(2) The workpiece measurement device according to (1) may include a measurement path display unit (for example, a UI display control unit 11a to be described below) configured to display the measurement point and the approach point set in the measurement program, and the measurement path including the measurement point and the approach point.

(3) In the workpiece measurement device according to (2), correction to the measurement point and the approach point displayed by the measurement path display unit and to the measurement path including the measurement point and the approach point may be accepted.

(4) The workpiece measurement device according to (1) to (3) may include a measurement program execution unit (for example, a measurement program execution unit 11f to be described below) configured to execute the measurement program, by moving a detector along the measurement path set in the measurement program.

(5) In the workpiece measurement device according to (1) to (4), the measurement program generation unit may generate the measurement program, by setting the measurement point and the approach point according to the measurement object structure, with respect to a template program according to a type of the measurement object structure and the measurement item.

(6) In the workpiece measurement device according to (1) to (5), the measurement item designation unit may rank and display candidate measurement items for the measurement object structure.

(7) In the workpiece measurement device according to (1) to (6), the image of the workpiece may be at least one of a two-dimensional image and a three-dimensional image of the workpiece and a CAD data image of the workpiece.

(8) In the workpiece measurement device according to (1) to (7), the detector may include at least one of a touch probe and a laser sensor.

(9) A workpiece measurement method according to the present invention to be executed by a computer includes a display step of displaying an image of a workpiece, a measurement object designation step of accepting designation of a measurement object in the image of the workpiece, a structure detection step of detecting a measurement object structure corresponding to the measurement object designated in the measurement object designation step, a measurement item designation step of accepting designation of a measurement item for the measurement object structure detected in the structure detection step, and a measurement program generation step of generating a measurement program including a set measurement point and a set approach point corresponding to the measurement item designated in the measurement item designation step with respect to the measurement object structure, and a set measurement path including the measurement point and the approach point.

(10) A program according to the present invention makes a computer execute a display control function to display an image of a workpiece, a measurement object designation function to accept designation of a measurement object in the image of the workpiece, a structure detection function to detect a measurement object structure corresponding to the measurement object designated by the measurement object designation function, a measurement item designation function to accept designation of a measurement item for the measurement object structure detected by the structure detection function, and a measurement program generation function to generate a measurement program including a set measurement point and a set approach point corresponding to the measurement item designated by the measurement item designation function with respect to the measurement object structure, and a set measurement path including the measurement point and the approach point.

The present invention enables to reduce the work load required to measure a workpiece.

### BRIEF DESCRIPTION OF THE DRAWINGS

FIG. 1 is a block diagram illustrating the configuration of a workpiece measurement device according to one embodiment of the present invention.

FIG. 2 is a schematic diagram illustrating one example of an operation performed on an input screen for designating a measurement object.

FIG. 3 is a schematic diagram illustrating another example of an operation performed on the input screen for designating a measurement object.

FIG. 4 is a schematic diagram illustrating another example of an operation performed on the input screen for designating a measurement object.

FIG. 5 is a schematic diagram illustrating another example of an operation performed on the input screen for designating a measurement object.

FIG. 6 is a schematic diagram illustrating another example of an operation performed on the input screen for designating a measurement object.

FIG. 7 is a schematic diagram illustrating one example of processing for extracting a structure (three-dimensional shape) upon the operation for designation input by a user.

FIG. 8 is a schematic diagram illustrating another example of processing for extracting a structure (three-dimensional shape) upon the operation for designation input by a user.

FIG. 9 is a schematic diagram illustrating another example of processing for extracting a structure (three-dimensional shape) upon the operation for designation input by a user.

FIG. 10 is a schematic diagram illustrating another example of processing for extracting a structure (three-dimensional shape) upon the operation for designation input by a user.

FIG. 11 is a schematic diagram illustrating conversion from a coordinate system of a display to a machine coordinate system.

FIG. 12 is a schematic diagram illustrating process of setting a measurement item for a measurement object structure.

FIG. 13 is a schematic diagram illustrating a concept in which a measurement program is automatically generated on the basis of a template program.

FIG. 14 is a schematic diagram illustrating the state in which measurement points and approach points are set, of the case of work set of a rectangular parallelepiped.

FIG. 15 is a schematic diagram illustrating the state in which the order of the approach points is set.

FIG. 16 is a schematic diagram illustrating the state in which paths connecting approach points are set.

FIG. 17 is a schematic diagram illustrating the state in which an approach point is set, of the case where the inner diameter of a hole is measured.

FIG. 18 is a schematic diagram illustrating the state in which measurement points are set, of the case where the inner diameter of a hole is measured.

FIG. 19 is a flowchart illustrating the flow of measurement program generation processing to be executed by the workpiece measurement device.

### DETAILED DESCRIPTION OF THE INVENTION

Some embodiments according to the present invention will be described below with reference to the drawings.

### [Configuration]

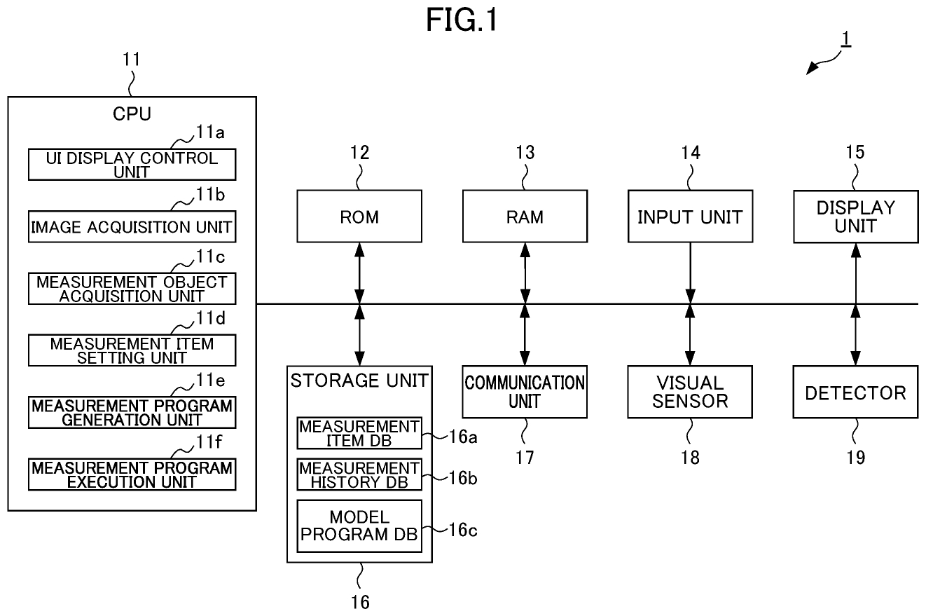

FIG. 1 is the block diagram illustrating the configuration of a workpiece measurement device 1 according to one embodiment of the present invention. The workpiece measurement device 1 is configured with an information processing device such as a numerical controller or a personal computer (PC). As illustrated in FIG. 1, the workpiece measurement device 1 includes a central processing unit (CPU) 11, a ROM 12, a RAM 13, an input unit 14, a display unit 15, a storage unit 16, a communication unit 17, and a visual sensor 18 and a detector 19.

The CPU 11 controls the entire workpiece measurement device 1 by executing various types of programs stored in the storage unit 16. In an example, the CPU 11 executes the program for processing automatic generation of a program for measuring a workpiece (hereinafter, also referred to as “measurement program generation processing”). The program for the measurement program generation processing is executed, whereby the CPU 11 obtains, as functional configurations, a UI display control unit 11a, an image acquisition unit 11b, a measurement object acquisition unit 11c, a measurement item setting unit 11d, a measurement program generation unit 11e and a measurement program execution unit 11f.

<UI Display Control Unit 11a>

The UI display control unit 11a displays a user interface screen (UI screen) allowing a user to input and output various types of information in the measurement program generation processing. In an example, as described below, the UI display control unit 11a displays the input screen for accepting the instruction to acquire an image of a workpiece serving as a measurement object, displays the input screen for designating a measurement object in the acquired image of the workpiece, and displays the detection result of the designated measurement object. The UI display control unit 11a further displays the input screen for accepting selection from among candidate measurement items, displays the input screen for setting an approach point or a measurement point for measuring a workpiece, and displays the input screen for correcting the automatically generated program for measuring a workpiece. The UI display control unit 11a is able to accept input via a mouse, a keyboard, a touch operation or the like. In an example, the UI display control unit 11a is able to accept not only various types of input forms via touch operations, but also drawing of an enclosing line by a direction key on a keyboard, drawing of a rectangular range via a drag operation with a mouse, drawing of a point by an enter key on a keyboard or via clicking of a mouse, or other drawing.

<Image Acquisition Unit 11b>

The image acquisition unit 11b acquires the image data of the workpiece captured by the visual sensor 18 (such as a depth camera or a stereo camera), or image data including the three-dimensional shape of the workpiece such as the computer aided design (CAD) data of the workpiece generated in a CAD system. The image acquisition unit 11b stores the acquired image data of the workpiece in the storage unit 16.

<Measurement Object Acquisition Unit 11c>

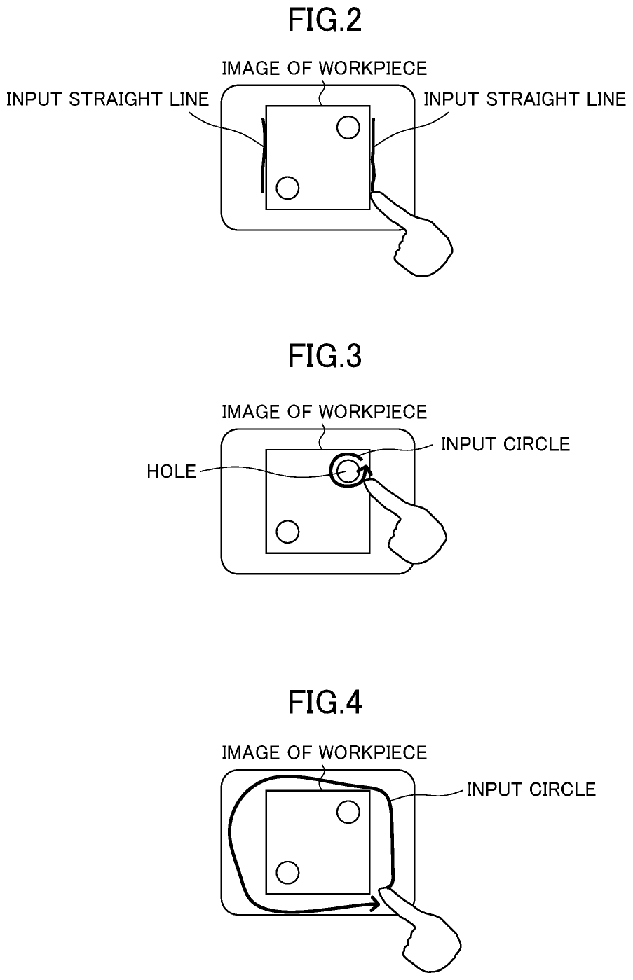

The measurement object acquisition unit 11c acquires the operation contents for designation input by a user on the input screen for designating the measurement object displayed on the UI screen by the UI display control unit 11a. The measurement object acquisition unit 11c then specifies the portion serving as a measurement object in the image of the workpiece according to the operation contents for designation input by the user, and detects the structure (three-dimensional shape) of the specified portion. The measurement object acquisition unit 11c further converts the detected structure from the plane coordinate system (image coordinate system) of the display to the three-dimensional coordinate system (machine coordinate system) on the stage on which the workpiece is placed. It is noted that the image coordinate system and the machine coordinate system herein are calibrated in advance and associated with each other. In this case, the coordinate system of a camera may be used instead of the plane coordinate system (image coordinate system) of the display. The contents of the detection processing by the measurement object acquisition unit 11c are described more specifically with reference to FIG. 2 to FIG. 10.

Each of FIG. 2 to FIG. 6 is a schematic diagram illustrating one example of the operation performed on the input screen for designating a measurement object. In the example illustrated in FIG. 2 as the operation contents for designation input by a user, straight lines are input respectively along the left and right sides of the image of a workpiece in the image of the workpiece serving as a measurement object. In the case of the example illustrated in FIG. 2, the measurement object acquisition unit 11c specifies that the user intends to measure the width of the workpiece. In the example illustrated in FIG. 3 as the operation contents for designation input by the user, a circle is input so as to enclose the hole formed in the workpiece, in the image of the workpiece serving as a measurement object. In the case of the example illustrated in FIG. 3, the measurement object acquisition unit 11c specifies that the user intends to measure the inner diameter of the hole formed in the workpiece.

In the example illustrated in FIG. 4 as the operation contents for designation input by the user, a circle is input so as to enclose the entire image of the workpiece, in the image of the workpiece serving as a measurement object. In the case of the example illustrated in FIG. 4, the user intends to the centering (origin setting) of the workpiece. In the example illustrated in FIG. 5, a rectangle is input, so as to designate the diagonal and enclose the entire image of the workpiece serving as a measurement object, in the image of the workpiece. In the case of the example illustrated in FIG. 5, the measurement object acquisition unit 11c specifies that the user intends to the centering (origin setting) of the workpiece.

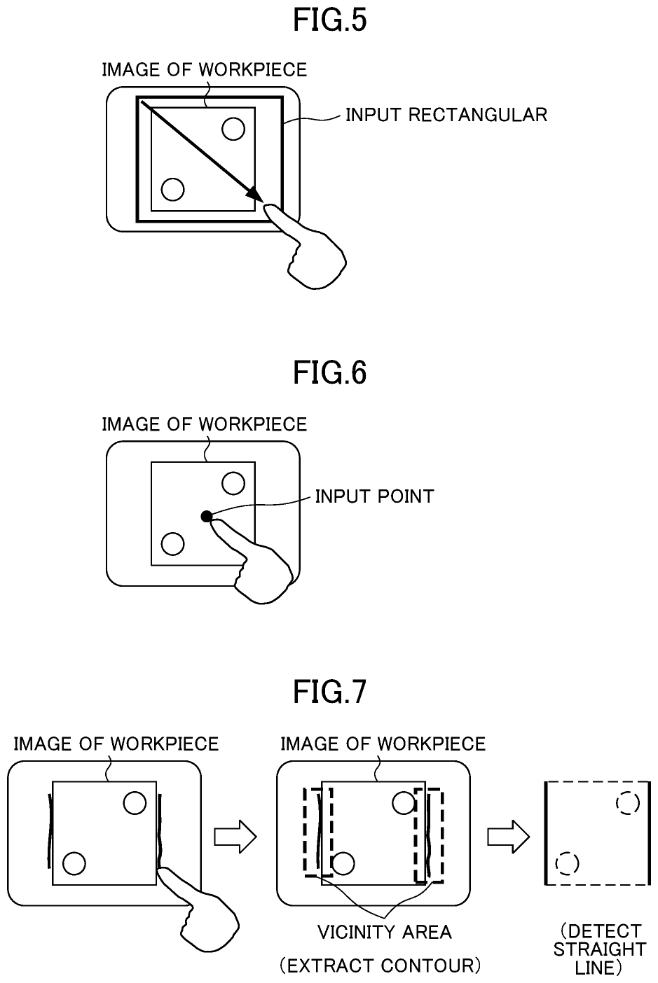

In the example illustrated in FIG. 6 as the operation contents for designation input by the user, a point inside the region of the workpiece is designated in the image of the workpiece serving as a measurement object. In the case of the example illustrated in FIG. 6, the measurement object acquisition unit 11c specifies that the user intends to the centering (origin setting) of the workpiece. In each of the examples illustrated in FIG. 4 to FIG. 6, the measurement object acquisition unit 11c extracts the contour of the workpiece. In the case where the contour is a two-dimensional quadrilateral shape, the measurement object acquisition unit 11c acquires the center point of the workpiece by measuring the four sides and the four vertexes.

Each of FIG. 7 to FIG. 10 is a schematic diagram illustrating one example of the processing in which the measurement object acquisition unit 11c extracts a structure (three-dimensional shape) upon the operation for designation input by the user. In the example illustrated in FIG. 7, as illustrated in FIG. 2, the user inputs straight lines respectively along the left and right sides of the image of the workpiece. The measurement object acquisition unit 11c sets a vicinity area of each segment (each of the input portions), extracts the contour thereof from the inside by Canny method, and thereafter detects two straight lines (the left and right outer edges of the workpiece) from the extracted contours by Hough transformation. It is noted that in the case where the contours are extracted as illustrated in FIG. 7, the measurement object acquisition unit 11c is able to determine that, as for the left side contour as one example, the object exists on the right side of the left side contour, on the basis that the right side pixel seen in a distance image has a convex value or that an object is detected in the right side by background subtraction.

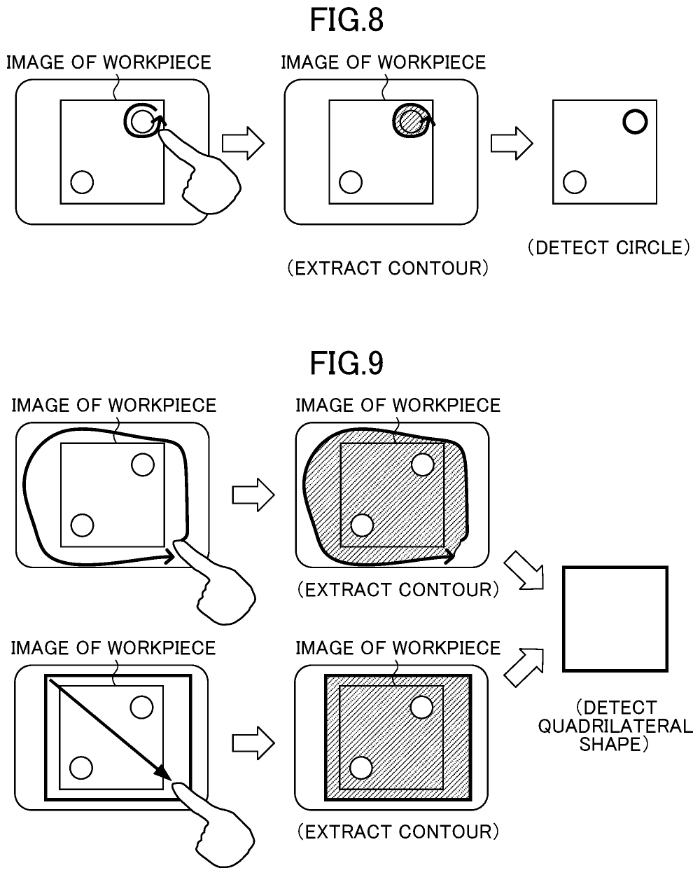

In the example illustrated in FIG. 8, the user inputs a circle so as to enclose the hole formed in the workpiece as illustrated in FIG. 3. In this case, the measurement object acquisition unit 11c extracts a contour by Snake method from the inside of the circle enclosing the hole formed in the workpiece, and further detects a circle (hole) by Hough transformation on the basis of the extracted contour. In the example illustrated in FIG. 9, the user inputs a circle or a rectangle so as to enclose the entire image of the workpiece as illustrated in FIG. 4 or FIG. 5. In this case, the measurement object acquisition unit 11c extracts a contour by Snake method from the inside of the circle or the rectangle enclosing the entire image of the workpiece, detects four straight lines by Hough transformation on the basis of the extracted contour, and detects a quadrilateral shape (upper, lower, left and right outer edges of the workpiece) on the basis of the detected four straight lines.

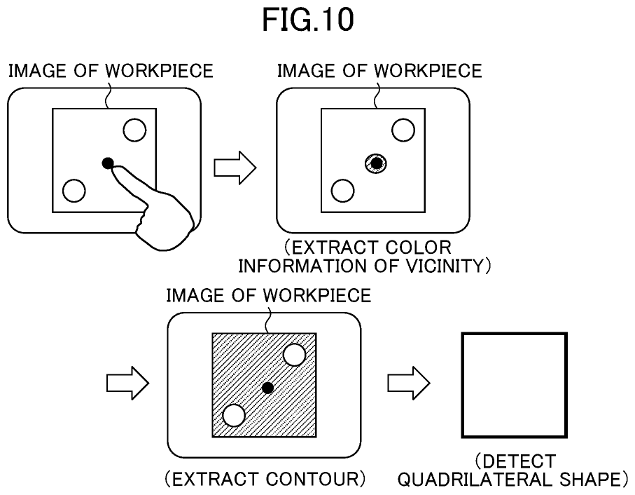

In the example illustrated in FIG. 10, the user designates a point in the region of the workpiece as illustrated in FIG. 6. In this case, the measurement object acquisition unit 11c extracts color information of the vicinity of the designated point from the designated point in the region of the workpiece, and extracts the region having the color similar to that of the vicinity of the designated point by region expansion method. The measurement object acquisition unit 11c then extracts a contour line by Snake method, detects four straight lines by Hough transformation on the basis of the extracted contour line, and detects a quadrilateral shape (upper, lower, left and right outer edges of the workpiece) on the basis of the four detected straight lines.

In each of the above-described examples, the structure is extracted through the two levels of processing in which a contour is first extracted by Snake method or Canny method, and thereafter a circle or a straight line is detected by Hough transformation. It is noted that the present invention is not limited thereto. The contour is extracted by Snake method or Canny method as a pretreatment for reducing erroneous detection at the time of Hough transformation. Thus, the contour extraction by Snake method or Canny method may be skipped.

In each of FIG. 9 and FIG. 10, the measurement object acquisition unit 11c extracts a quadrilateral shape representing the contour of the workpiece, thereby enabling to present measurement items to a user, by picking up only measurable items such as the center point and the area of the quadrilateral shape, as examples. The measurement object acquisition unit 11c uses the topology information indicating that “the contour constitutes a closed figure of a quadrilateral shape,” not by individually managing the four extracted line segments, thereby enabling to determine on which side of each of the line segments an object exists, on the basis of the positional relation between the center of the quadrilateral shape and each of the line segments. As described below, the measurement item setting unit 11d is able to use the determination as auxiliary information for setting the direction to move a touch probe at the time of measurement.

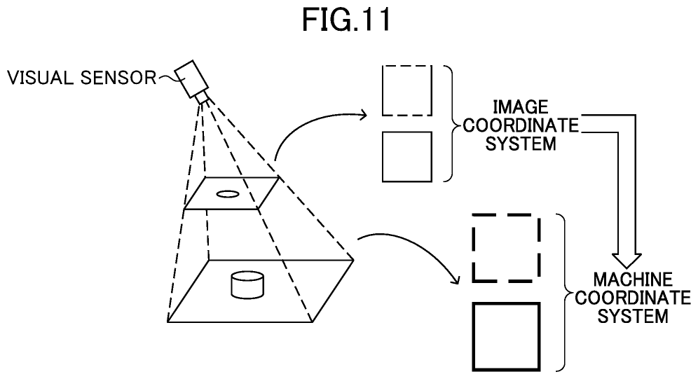

FIG. 11 is the schematic diagram illustrating the conversion from the coordinate system of the display to the machine coordinate system. As illustrated in FIG. 11, the measurement object acquisition unit 11c converts the plane coordinate (image coordinate) of the display with respect to the structure (such as the left and right outer edges of the workpiece, the hole, the upper, lower, left and right outer edges of the workpiece) detected as a measurement object to the three-dimensional coordinate (machine coordinate) on the stage. As a result, the measurement object acquisition unit 11c is able to acquire position information related to the physical three-dimensional shape of the measurement object designated on the UI screen by the user.

<Measurement Item Setting Unit 11d>

The measurement item setting unit 11d sets the measurement items with respect to the measurement object structure detected by the measurement object acquisition unit 11c, by referring to a database (a measurement item database 16a in the storage unit 16) in which the types of measurement items are defined. The measurement item setting unit 11d makes the list of the items to be selected as measurement items (candidate measurement items), by referring to past measurement history information (a measurement history database 16b in the storage unit 16) on the basis of the measurement object structure detected by the measurement object acquisition unit 11c.

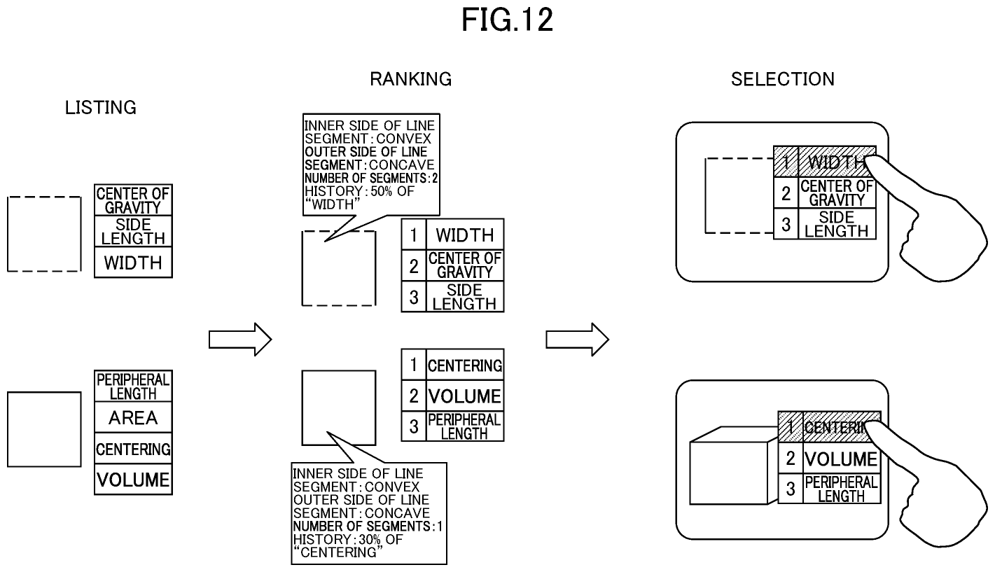

The measurement item setting unit 11d further ranks the candidate measurement items in the list. Specifically, the measurement item setting unit 11d ranks the candidate measurement items in the list, by referring to the type, the shape and the machining status (before machining, during machining, after machining) of the structure, the contents of a machining program, past measurement history, and the like. The UI display control unit 11a displays the candidate measurement items ranked by the measurement item setting unit 11d on the UI screen in the order of the ranking, thereby allowing a user to select any one. The processing contents of setting the measurement item with respect to the measurement object structure to be performed by the measurement item setting unit 11d are described more specifically with reference to FIG. 12.

FIG. 12 is the schematic diagram illustrating the process in which the measurement item with respect to the measurement object structure is set. As illustrated in FIG. 12, when the measurement object acquisition unit 11c detects the measurement object structure, the measurement item setting unit 11d makes the list of the items to be selected as a measurement item (candidate measurement items), by referring to the measurement history database 16b in the storage unit 16.

In the example illustrated in FIG. 12 of the case where the measurement object acquisition unit 11c detects the left and right outer edges of the workpiece, the measurement item setting unit 11d makes the list of “center of gravity,” “side length” and “width” as candidate measurement items. In the case where the measurement object acquisition unit 11c detects the upper, lower, left and right outer edges of the workpiece, the measurement item setting unit 11d makes the list of “peripheral length,” “area,” “centering” and “volume” as candidate measurement items. As illustrated in FIG. 12, the measurement item setting unit 11d ranks the candidate measurement items in the list by, for example, referring to the execution frequencies of the measurement items of the case of the measurement object similar to the current measurement object in the past measurement history. In the example illustrated in FIG. 12 of the case where the measurement object acquisition unit 11c detects the left and right outer edges of the workpiece, the measurement item setting unit 11d ranks the candidate measurement items in the order of “width,” “center of gravity” and “side length,” by referring to the fact that “the inner side of the line segment has a convex volume,” “the outer side of the line segment has a concave volume” and “the number of the segments is 2” with respect to the measurement object structure, and the fact that “the frequency of measuring the width of a workpiece is 50%” in the past measurement history for the similar structures serving as measurement objects. In the case where the measurement object acquisition unit 11c detects the upper, lower, left and right outer edges of the workpiece, the measurement item setting unit 11d ranks the candidate measurement items in the order of “centering,” “volume” and “peripheral length,” by referring to the fact that “the inner side of the line segment has a convex volume,” “the outer side of the line segment has a concave volume” and “the number of the segment is 1” with respect to the measurement object structure, and the fact that “the frequency of centering a workpiece is 30%” in the past measurement history for the similar structures serving as measurement objects. As illustrated in FIG. 12, the ranked candidate measurement items are displayed on the UI screen in the order of the ranking by the UI display control unit 11a, thereby allowing a user to select any one. In the example illustrated in FIG. 12 of the case where the left and right outer edges of the workpiece are detected, the user selects “width” from among “width,” “center of gravity” and “side length” in the list of the candidate measurement items. In the example illustrated in FIG. 12 of the case where the upper, lower, left and right outer edges of the workpiece are detected, the user selects “centering” from among “centering,” “volume” and “peripheral length” in the list of the candidate measurement items.

<Measurement Program Generation Unit 11e>

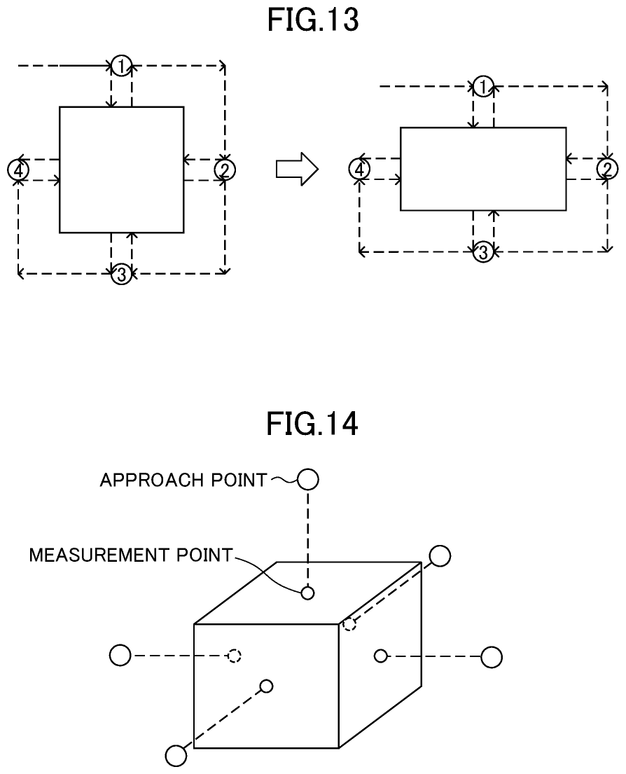

In the case where the user selects one measurement item, the measurement program generation unit 11e sets the predetermined number of the approach points and the predetermined number of the measurement points according to the selected measurement item. The measurement program generation unit 11e is able to acquire the program of a model (hereinafter, referred to as “a model program”) corresponding to the measurement object and the selected measurement item from a model program database 16c in the storage unit 16. The model program includes the previously-set policy for setting measurement points and approach points corresponding to various types of measurement items. The measurement program generation unit 11e sets the measurement points and the approach points of the model program, on the basis of the specific configuration of the measurement object structure detected by the measurement object acquisition unit 11c. The measurement program generation unit 11e further automatically generates a measurement path connecting between two approach points, and a measurement path from one approach point to one measurement point, on the basis of the previously-set setting policy. With this operation, the program (measurement program) for measuring the measurement object is generated automatically. The measurement program automatically generated by the measurement program generation unit 11e is simulated, whereby the UI display control unit 11a displays the approach points, the measurement points and the measurement paths of the measurement program on the UI screen. It is noted that the measurement program generation unit 11e is also able to set measurement points, approach points and measurement paths, on the basis of the specific configuration of the measurement object structure detected by the measurement object acquisition unit 11c, without using the model program. The contents of the measurement program generation processing executed by the measurement program generation unit 11e are described more specifically with reference to FIG. 13.

FIG. 13 is the schematic diagram illustrating the concept in which a measurement program is automatically generated on the basis of the model program by the measurement program generation unit 11e. As illustrated in FIG. 13, the model program database 16c in the storage unit 16 stores the previously-registered model programs corresponding to the shapes of workpieces. The model program database 16c stores, for example, the model for measuring one point for each face of the four side faces of a rectangular parallelepiped, the model for measuring one point for each face of the three side faces of a triangular prism, and the model for measuring the inner diameter of a column by moving a probe from the center of the circle to the outside thereof. In an example, as illustrated in FIG. 13, the model for a rectangular parallelepiped is expanded and contracted according to the positions of approach points. That is, only topology such as the order of the approach points and the direction in which a probe is moved is registered as a model in the model program database 16c. The measurement program generation unit 11e generates a measurement program by substituting actual values for approach points in the model program.

In the case where the user performs input for correction to the source list of the measurement program displayed on the UI screen, the measurement program generation unit 11e reflects the input correction on the measurement program. The UI display control unit 11a simulates the measurement program in which the correction by the user is reflected, thereby displaying the approach points, the measurement points and the measurement paths after the correction on the UI screen. The user approves the measurement points and the measurement paths displayed on the UI screen, thereby establishing the measurement program based on the approved approach points, the approved measurement points and the approved measurement paths.

<Measurement Program Execution Unit 11f>

The measurement program execution unit 11f executes the measurement program (established measurement program) generated by the measurement program generation unit 11e and moves the detector 19 (such as a touch probe or a laser sensor), thereby measuring the measurement object. The description above is about the functional blocks formed in the CPU 11 by executing the programs for the measurement program generation processing in the workpiece measurement device 1. Other components included in the workpiece measurement device 1 are described below with reference to FIG. 1.

The ROM 12 includes various types of previously-written system programs for controlling the workpiece measurement device 1. The RAM 13, which is configured with a semiconductor memory such as a dynamic random-access memory (DRAM), stores data generated when the CPU 11 executes various types of processing. The input unit 14, which is configured with an input device such as a keyboard, a mouse, or a touch sensor (touch panel), accepts various types of information input by a user into the workpiece measurement device 1.

The display unit 15, which is configured with a display device such as a liquid crystal display (LCD), displays various types of processing results of the workpiece measurement device 1. The storage unit 16, which is configured with a non-volatile storage device such as a hard disk or a flash memory, stores a program for measurement program generation processing and the like. As described above, the storage unit 16 stores the measurement item database (measurement item DB) 16a in which the types of measurement items are defined, the measurement history database (measurement history DB) 16b in which the past measurement history is stored, and the model program database (model program DB) 16c in which the measurement program models are stored. The storage unit 16 further stores various types of processing results of the workpiece measurement device 1, such as established measurement programs and execution results of the measurement programs.

The communication unit 17, which includes a communication interface for processing signals on the basis of a predetermined communication standard such as a wired or wireless LAN or USB, controls the communication performed between the workpiece measurement device 1 and other devices.

The visual sensor 18, which includes an imaging device for capturing a three-dimensional image such as a depth camera or a stereo camera, captures a three-dimensional image of a workpiece serving as a measurement object. It is noted that the visual sensor 18 may include an imaging device for capturing a two-dimensional image of a workpiece. The detector 19, which includes a touch probe, a laser sensor or the like, detects the position of a point in a workpiece serving as a measurement object.

### SPECIFIC APPLICATION EXAMPLE

The next descriptions with reference to FIG. 14 to FIG. 18 are about the specific examples of the cases where the workpiece measurement device 1 automatically generates the measurement program for centering of a workpiece before machining, and the measurement program for measuring the inner diameter of the hole formed in the workpiece after machining.

### Specific Application Example 1

### <Measurement Program for Centering>

The description right below with reference to FIG. 14 to FIG. 16 is about the procedure for automatically generating the measurement program for centering of a workpiece before machining. In the present example, the measurement program for centering (in a three-dimensional space) of a workpiece before machining is automatically generated on the premise that a rectangular parallelepiped is used as a measurement object, and that the workpiece is imaged from directly above by a three-dimensional camera, as an imaging condition.

In this case, the measurement program is automatically generated according to the following procedure.

(Procedure 1) A user designates a measurement object (quadrilateral shape) by the enclosing operation illustrated in FIG. 4 on the input screen for designating a measurement object displayed on the UI screen by the UI display control unit 11a.

(Procedure 2) The measurement object acquisition unit 11c extracts the quadrilateral shape by performing image processing (for example, Hough transformation or Snake method) to the measurement object designated by the enclosing operation.

(Procedure 3) The measurement item setting unit 11d makes the list of the measurement items to be selected, by referring to the past measurement history information (the measurement history database 16b in the storage unit 16), on the basis of the measurement object structure detected by the measurement object acquisition unit 11c. More specifically, the measurement item setting unit 11d narrows down and ranks the measurement items to be selected by use of the following conditions.
Shape of workpiece (for example, the extracted quadrilateral shape corresponding to the rectangular parallelepiped in which the quadrilateral shape protrudes from the periphery in the Z direction)
Status of workpiece (for example, before machining)
Contents of machining program (for example, cutting of an outer face of the workpiece)
Past measurement history (for example, with a frequency of 80% of centering measurement in the case where “a quadrilateral shape” is input so as to “enclose and designate” “the outside of an object” “before machining”)

(Procedure 4) The user selects “centering” from among the candidate measurement items in the list made by the measurement item setting unit 11d.

(Procedure 5) The measurement program generation unit 11e sets five measurement points respectively at the centers of the five faces of the rectangular parallelepiped, and sets five approach points respectively at the positions away from the measurement points by a fixed distance in the normal directions of the faces. The height in the Z direction at the center of the measurement plane is obtained by, for example, dividing by two the sum of the outside height and the inside height of the outer edge portion of the quadrilateral shape obtained by a three-dimensional camera. The height in the Z direction may be obtained by imaging the quadrilateral shape by use of a three-dimensional camera, may be calculated on the basis of the machining program of the workpiece, may be obtained from the CAD data of the workpiece, or may be obtained on the basis of the size of the object in a two-dimensional camera image.

FIG. 14 is the schematic diagram illustrating the state in which measurement points and approach points are set, of the case of centering of the rectangular parallelepiped. The procedure 5 is performed, whereby the measurement points and the approach points are set as illustrated in FIG. 14. In the model program for centering of a rectangular parallelepiped, the policy for setting measurement points and approach points as illustrated in FIG. 14 is predetermined with respect to a measurement-object rectangular parallelepiped. Accordingly, in the case of using a model program, the measurement program generation unit 11e is able to easily set measurement points and approach points.

(Procedure 6) The measurement program generation unit 11e generates a measurement path connecting between two approach points as follows.
Set as the first approach point the approach point nearest in the straight line from the current position (initial position) of the touch probe.
Set as the second approach point the approach point nearest in the straight line from the first approach point, and set the order to all the approach points in the same manner.
Generate a path so as not to come into contact with an object, by connecting between an Nth approach point and an (N+1)th approach point (wherein N is a natural number).

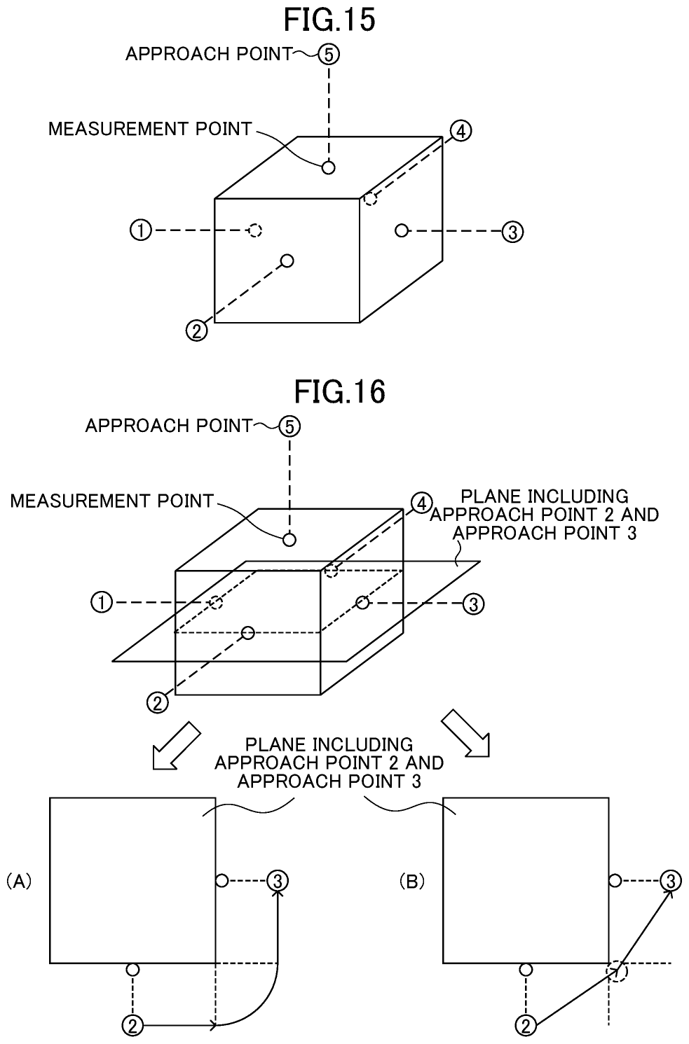

FIG. 15 is the schematic diagram illustrating the state in which the order of the approach points is set. FIG. 16 is the schematic diagram illustrating the state in which a path connecting between two approach points is set. FIG. 16 illustrates the examples in two forms each for setting a measurement path: (A) the case of keeping a fixed distance from a measurement object; and (B) the case of setting a shortest path between two approach points. It is noted that in the case of setting a shortest path between two approach points, the margin having at least the length of the radius of a probe from the measurement object needs to be secured.

(Procedure 7) The measurement program generation unit 11e generates a measurement path from one approach point to one measurement point as follows.
Move the probe along the straight line connecting from one approach point to one measurement point, and move the probe back to the approach point when the probe comes into contact with the workpiece.

### Specific Application Example 2

<Measurement Program for Measuring the Inner Diameter of the Hole Formed in the Workpiece after Machining>

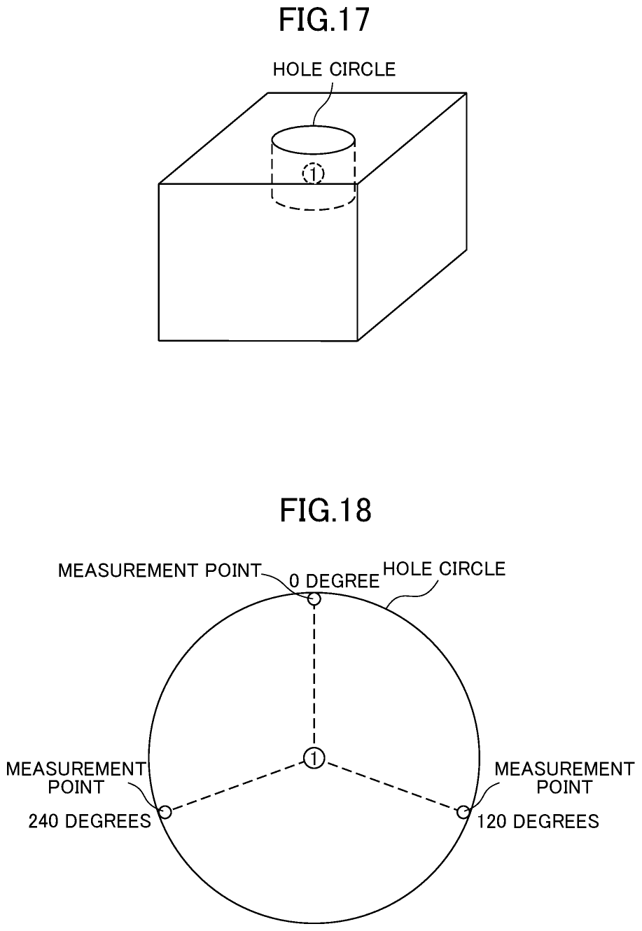

The next description with reference to FIG. 17 and FIG. 18 is about the example in which the measurement program for measuring the inner diameter of the hole formed in the workpiece after machining is generated automatically. In the present example, the measurement program for measuring the inner diameter (in a three-dimensional space) of the hole formed in the workpiece after machining is automatically generated on the premise that a rectangular parallelepiped is used as a measurement object, and that the workpiece is imaged from directly above by a three-dimensional camera, as an imaging condition.

In this case, the measurement program is automatically generated according to the following procedure.

(Procedure 1) A user designates a measurement object (hole circle) by the enclosing operation (refer to FIG. 3) on the input screen for designating a measurement object displayed on the UI screen by the UI display control unit 11a.

(Procedure 2) The measurement object acquisition unit 11c extracts a circle by performing imaging processing (for example, Hough transformation or Snake method) to the measurement object designated by the enclosing operation.

(Procedure 3) The measurement item setting unit 11d makes the list of the measurement items to be selected, by referring to the past measurement history information (the measurement history database 16b in the storage unit 16), on the basis of the measurement object structure detected by the measurement object acquisition unit 11c.
Shape of workpiece (for example, the extracted quadrilateral shape corresponding to the rectangular parallelepiped in which the quadrilateral shape protrudes from the periphery in the Z direction)
Status of workpiece (for example, after machining)
Contents of machining program (for example, hole drilling of the workpiece)
Past measurement history (for example, with a frequency of 70% of measuring of an inner diameter in the case where “a circle” is input so as to “enclose and designate” “the inside of an object” “after machining”)

(Procedure 4) The user selects “inner diameter” from among the candidate measurement items in the list made by the measurement item setting unit 11d.

(Procedure 5) The measurement program generation unit 11e sets an approach point at the center of the circle. The height in the Z direction of the approach point is obtained by dividing by two the sum of the outside height and the inside height of the edge portion of the circle extracted from the image captured by a three-dimensional camera.

FIG. 17 is the schematic diagram illustrating the state in which the approach point is set, of the case where the inner diameter of the hole is measured. The procedure 5 is performed, whereby the approach point is set at the center of the circle and at the height in the Z direction according to the setting policy, as illustrated in FIG. 17.

(Procedure 6) The measurement program generation unit 11e uses, as measurement points, three intersections of the circumference of the hole circle and the three straight lines extending from the approach point in the direction of 0 degree, the direction of 120 degrees and the direction of 240 degrees in the machine coordinate system. FIG. 18 is the schematic diagram illustrating the state in which the measurement points are set, of the case where the inner diameter of the hole is measured. Procedure 6 is performed, whereby the measurement points are set at the positions on the circumference of 0 degree, 120 degrees and 240 degrees in the machine coordinate system from the approach point set at the center of the circle, as illustrated in FIG. 18.

(Procedure 7) The measurement program generation unit 11e generates the measurement paths from the approach point to the measurement points as follows.
Move the probe along the straight line connecting from the approach point to one measurement point, move the probe back to the approach point when the probe comes into contact with the workpiece, and move the probe to the next measurement point.
Alternatively, move the probe along the straight line connecting from the approach point to the first measurement point, and then move the probe directly to the next measurement point when the probe comes into contact with the workpiece.

The measurement program generation unit 11e is able to set either pattern to generate measurement paths, by switching the mode or the like. The embodiments of the respective functional parts of the workpiece measurement device 1 according to the present invention have been described so far on the basis of the configuration of the workpiece measurement device 1.

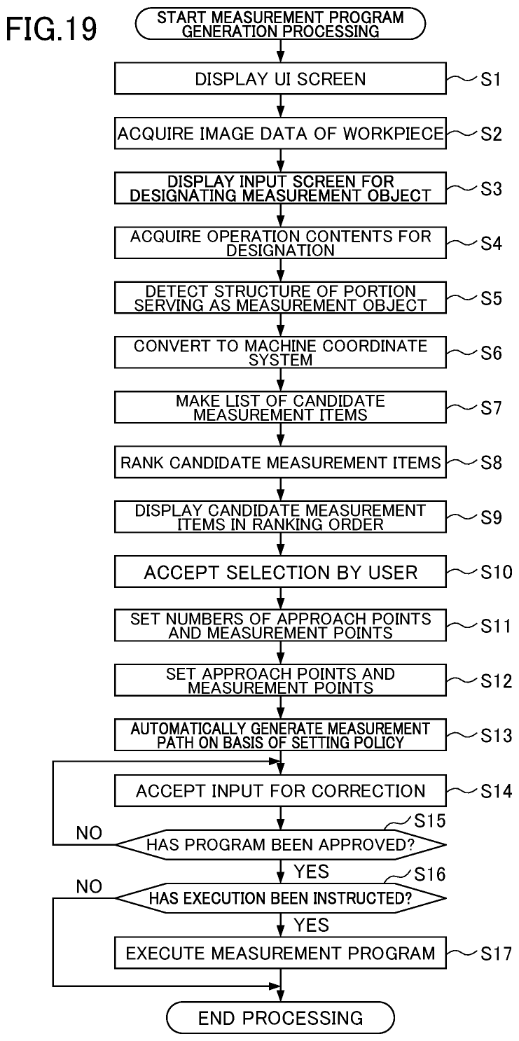

The next description with reference to FIG. 19 is about the flow of the processing by the workpiece measurement device 1.

### <Measurement Program Generation Processing>

FIG. 19 is the flowchart for explaining the flow of the measurement program generation processing to be executed by the workpiece measurement device 1. The measurement program generation processing is started upon the reception of the instruction to start the measurement program generation processing via the input unit 14.

In step S1, the UI display control unit 11a displays the user interface screen (UI screen) allowing a user to input and output various type of information in the measurement program generation processing. In step S2, the image acquisition unit 11b acquires image data including the three-dimensional shape of the workpiece, such as the image data of the workpiece imaged by the visual sensor 18 (a depth camera, a stereo camera or the like) or the computer aided design (CAD) data of the workpiece generated in a CAD system. The image data of the workpiece acquired at this time is stored in the storage unit 16. In step S3, the UI display control unit 11a displays the input screen for designating a measurement object in the acquired image of the workpiece.

In step S4, the UI display control unit 11a acquires the operation contents for designation input by the user on the input screen for designating a measurement object. In step S5, the measurement object acquisition unit 11c designates the portion corresponding to the measurement object in the image of the workpiece according to the operation contents for designation input by the user, and detects the structure (three-dimensional shape) of the designated portion.

In step S6, the measurement object acquisition unit 11c converts the detected structure from the plane coordinate system (image coordinate system) of the display to the three-dimensional coordinate system (machine coordinate system) on the stage on which the workpiece is placed. In step S7, the measurement item setting unit 11d makes the list of the items to be selected as measurement items (candidate measurement items), by referring to the past measurement history (the measurement history database 16b in the storage unit 16) on the basis of measurement object structure detected by the measurement object acquisition unit 11c.

In step S8, the measurement item setting unit 11d ranks the candidate measurement items in the list on the basis of the past measurement history or the like. In step S9, the UI display control unit 11a displays the candidate measurement items ranked by the measurement item setting unit 11d in the order of the ranking on the UI screen. In step S10, the UI display control unit 11a displays the input screen for accepting selection from among the candidate measurement items, and accepts the selection by the user.

In step S11, the measurement program generation unit 11e sets the predetermined number of the approach points and the predetermined number of the measurement points according to the measurement item selected by the user. In step S12, the measurement program generation unit 11e sets the approach points and the measurement points of the model program, on the basis of the specific configuration of the measurement object structure. In step S13, the measurement program generation unit 11e automatically generates a measurement path connecting between two approach points, and a measurement path from one approach point to one measurement point, on the basis of the predetermined setting policy. The approach points, the measurement points and the measurement paths generated as above of the measurement program are displayed on the UI screen by the UI display control unit 11a. It is noted that in step S11 to step S13 the measurement program generation unit 11e may acquire the model program corresponding to the measurement object and the selected measurement item, and may set the approach points and the measurement points of the model program, and the measurement paths, on the basis of the specific configuration of the measurement object structure.

In step S14, the measurement program generation unit 11e accepts the input for correction from the user with respect to the source list of the measurement program displayed on the UI screen. In step S15, the UI display control unit 11a determines whether or not the measurement program has been approved by the user. In the case where the measurement program has not been approved by the user, NO is obtained as the determination in step S15, and the processing proceeds to step S14. On the other hand, in the case where the measurement program has been approved by the user, YES is obtained as the determination in step S15, and the processing proceeds to step S16.

In step S16, the measurement program execution unit 11f determines whether or not the execution of the measurement program has been instructed. In the case where the execution of the measurement program has been instructed, YES is obtained as the determination in step S16, and the processing proceeds to step S17. On the other hand, in the case where the execution of the measurement program has not been instructed, NO is obtained as the determination in step S16, and the measurement program generation processing ends. In step S17, the measurement program execution unit 11f executes the measurement program. After step S17, the measurement program generation processing ends.

As described above, the workpiece measurement device 1 according to the present embodiment accepts the operation of designating a measurement object by a user in the image of a workpiece. The workpiece measurement device 1 specifies the portion corresponding to the measurement object in the image of the workpiece according to the designation by the user, and detects the structure (three-dimensional shape) of the specified portion. The workpiece measurement device 1 further accepts the input of the measurement item with respect to the detected structure, and automatically sets the measurement points and the approach points according to the measurement item, and the measurement paths including the measurement points and the approach points. The operation of designating the measurement object in the image of the workpiece serving as the measurement object, and the operation of inputting the measurement item are executed, thereby automatically generating the measurement program for automatically measuring the workpiece serving as the measurement object. Accordingly, the work load required to measure the workpiece is enabled to be reduced.

In the workpiece measurement device 1, the user inputs the operation of enclosing the image of the workpiece, the operation of inputting a straight line, the operation of designating a point or another operation, in order to designate the measurement object in the image of the workpiece, whereby the portion corresponding to the measurement object is specified in the image of the workpiece by imaging processing. Accordingly, the user is able to designate the measurement object by a simple operation.

In the workpiece measurement device 1, the measurement items with respect to the detected structure are displayed in a list and ranked on the basis of type, shape and machining status of the structure, contents of the machining program, past measurement history and the like. This operation enables to present, to the user who selects the measurement item, the measurement items that are likely to be executed in an easy-to-understand manner.

The workpiece measurement device 1 acquires the model program corresponding to the detected structure (measurement object) and the selected measurement item, and sets the measurement points and the approach points according to the specific configuration of the measurement object structure. This operation enables to more easily generate the measurement program for automatically measuring the measurement object.

### [Modification 1]

In the description of the above embodiment, a user designates a measurement object, and a user inputs a measurement item. Alternatively, in the case of determining that a measurement program is decidable uniquely for a measurement object, the workpiece measurement device 1 is able to automatically generate the measurement program, by omitting the designation of a measurement object and the input of a measurement item. In this case, the workpiece measurement device 1 is able to determine whether or not the measurement program is decidable uniquely for the measurement object, for example, on the basis that the measurement object, the measurement item and the like are designated by the user in advance, that the automatic selection is set so that the measurement item having the highest frequency in selection is selected from among the candidate measurement items ranked on the basis of the past measurement history, and that the measurement program is limited to one type. As another modification, the workpiece measurement device 1 may be configured without a measurement object designation unit or a measurement item designation unit. In this case, the workpiece measurement device 1 may automatically generate the measurement program, for example, on the basis that the measurement object, the measurement item and the like are designated in advance, that the automatic selection is set so that the measurement item having the highest frequency in selection is selected from among the candidate measurement items ranked on the basis of the past measurement history, and that the measurement program is determined in advance for each type of workpiece.

### [Modification 2]

When workpieces in one type are mass-produced, the measurement program generated for the first workpiece and the image of the workpiece are saved. As for the second and the following workpieces, the shift amounts of the positions and the angles from the image of the first workpiece are calculated, and the shift amounts are added to the coordinate values of the measurement program generated for the first workpiece, so that the program is corrected. Thereby, the measurement operation may be fully automated, by skipping the user's operation of designating a measurement object and the user's operation of determining a measurement item, with respect to the second and the following workpieces.

### [Modification 3]

In the description of the above embodiment, the operation of designating a measurement object is accepted, and the measurement object structure is detected, and thereafter the input of a measurement item is accepted. Alternatively, the input of a measurement item may be accepted, and thereafter the operation of designating a measurement object may be accepted, and the measurement object structure may be detected. With this operation, a measurement object is limited by the designation of the measurement item, thereby enabling to more appropriately detect the measurement object structure.

The present invention is not limited to the above-described embodiment or modifications. Various changes, modifications and the like are available. In an example, although the detector 19 includes a touch probe or a laser sensor in the description of the above embodiment, the present invention is not limited thereto. That is, any device capable of measuring the position or the shape of the workpiece serving as a measurement object is able to use various types of detectors.

Although the image data including the three-dimensional shape of the workpiece is used as the image of the workpiece serving as a measurement object in the description of the above embodiment, the present invention is not limited thereto. In an example, the image including the two-dimensional shape of the workpiece may be used additionally with other auxiliary information (such as a machining program), thereby, as the whole of the information, recognizing the three-dimensional shape of the workpiece.

In the above-described embodiment, in the case where the detector 19 is moved from one approach point to one measurement point, the detector 19 may be moved at a high speed to the position before the measurement point by a predetermined distance in the measurement path, and may be moved at a low speed from the measurement point by the predetermined distance. As a result, the workpiece and the detector 19 are able to be more gently brought into contact with each other, and in addition the measurement time is able to be shortened.

All or some of the functions of the workpiece measurement device 1 according to the embodiment described above are able to be realized by hardware, software, or the combination of these. Being realized by software herein means that a processor reads and executes a program, whereby a function is realized. In the case of the configuration with hardware, some or all of the functions of the workpiece measurement device 1 may be configured with an integrated circuit (IC), for example, an application specific integrated circuit (ASIC), a gate array, a field programmable gate array (FPGA), or a complex programmable logic device (CPLD).

In the case where all or some of the functions of the workpiece measurement device 1 are configured with software, a computer is configured with a storage unit such as the hard disk and the ROM storing the programs writing all or some of the operations of the workpiece measurement device 1, the DRAM storing data required for calculation, CPU, and the buses connecting respective devices, and in the computer the DRAM stores the information required for calculation, and the CPU makes the programs operate, thereby enabling to realize the functions.

These programs are able to be provided to computers, by being stored in various types of computer readable media. The examples of the computer readable media include various types of tangible storage media. The examples of the computer readable media include magnetic storage medium (for example, flexible disk, magnetic tape, hard disk drive), magneto-optical storage medium (for example, magneto-optical disk), CD-read only memory (ROM), CD-R, CD-R/W, digital versatile disk (DVD)-ROM, DVD-R, DVD-R/W, semiconductor memory (for example, mask ROM, programmable ROM (PROM), erasable PROM (EPROM), flash memory, random access memory (RAM)). These programs may be distributed by being downloaded to a user's computer via a network.

The embodiments according to the present invention have been detailed so far. The above-described embodiments are indicated merely as the specific examples embodying the present invention. The technical scopes of the present invention are not limited to the above embodiments. Various modifications are available without departing from the scopes of the present invention, and such modifications are also included in the technical scopes of the present invention.

### EXPLANATION OF REFERENCE NUMERALS

1 WORKPIECE MEASUREMENT DEVICE
11 CPU
11a UI DISPLAY CONTROL UNIT
11b IMAGE ACQUISITION UNIT
11c MEASUREMENT OBJECT ACQUISITION UNIT
11d MEASUREMENT ITEM SETTING UNIT
11e MEASUREMENT PROGRAM GENERATION UNIT
11f MEASUREMENT PROGRAM EXECUTION UNIT
12 ROM
13 RAM
14 INPUT UNIT
15 DISPLAY UNIT
16 STORAGE UNIT
16a MEASUREMENT ITEM DATABASE
16b MEASUREMENT HISTORY DATABASE
16c MODEL PROGRAM DATABASE
17 COMMUNICATION UNIT
18 VISUAL SENSOR
19 DETECTOR

What is claimed is:

1. A workpiece measurement device comprising:
a display unit configured to display an image of a workpiece;
a measurement object designation unit configured to accept designation of a measurement object in the image of the workpiece;
a structure detection unit configured to detect a measurement object structure corresponding to the measurement object designated by the measurement object designation unit;
a measurement item designation unit configured to accept designation of a measurement item in the image of the workpiece; and
a measurement program generation unit configured to generate a measurement program including a set measurement point and a set approach point corresponding to the measurement item designated by the measurement item designation unit with respect to the measurement object structure, and a set measurement path including the measurement point and the approach point.

2. The workpiece measurement device according to claim 1, the workpiece measurement device comprising:
a measurement path display unit configured to display the measurement point and the approach point set in the measurement program, and the measurement path including the measurement point and the approach point.

3. The workpiece measurement device according to claim 2, wherein
the measurement program generation unit accepts correction to the measurement point and the approach point displayed by the measurement path display unit and to the measurement path including the measurement point and the approach point.

4. The workpiece measurement device according to claim 1, the workpiece measurement device comprising:
a measurement program execution unit configured to execute the measurement program, by moving a detector along the measurement path set in the measurement program.

5. The workpiece measurement device according to claim 1, wherein
the measurement program generation unit generates the measurement program, by setting the measurement point and the approach point according to the measurement object structure, with respect to a model program according to a type of the measurement object structure and the measurement item.

6. The workpiece measurement device according to claim 1, wherein
the measurement item designation unit ranks and displays candidate measurement items for the measurement object structure.

7. The workpiece measurement device according to claim 1, wherein
the image of the workpiece is at least one of a two-dimensional image and a three-dimensional image of the workpiece and a CAD data image of the workpiece.

8. The workpiece measurement device according to claim 1, wherein
the detector includes at least either of a touch probe and a laser sensor.

9. A workpiece measurement method to be executed by a computer, the workpiece measurement method comprising:
a display step of displaying an image of a workpiece;
a measurement object designation step of accepting designation of a measurement object in the image of the workpiece;
a structure detection step of detecting a measurement object structure corresponding to the measurement object designated in the measurement object designation step;
a measurement item designation step of accepting designation of a measurement item for the measurement object structure detected in the structure detection step; and
a measurement program generation step of generating a measurement program including a set measurement point and a set approach point corresponding to the measurement item designated in the measurement item designation step with respect to the measurement object structure, and a set measurement path including the measurement point and the approach point.

10. A non-transitory computer readable recording medium recording a program configured to make a computer execute:
a display control function to display an image of a workpiece;
a measurement object designation function to accept designation of a measurement object in the image of the workpiece;
a structure detection function to detect a measurement object structure corresponding to the measurement object designated by the measurement object designation function;
a measurement item designation function to accept designation of a measurement item for the measurement object structure detected by the structure detection function; and
a measurement program generation function to generate a measurement program including a measurement point and an approach point corresponding to the measurement item designated by the measurement item designation function with respect to the measurement object structure, and a measurement path including the measurement point and the approach point.
